(19) United States
(12) Patent Application Publication
(10) Pub. No.: US 2022/0217907 A1
(43) Pub. Date: Jul. 14, 2022

(54) INTEGRATING LIQUID DISPENSING CONTROL WITH RIDING MOWER STEERING

(71) Applicants: Benjamin Franklin HARDY, Nampa, ID (US); Merle Clark HARDY, Thompson, ID (US)

(72) Inventors: Benjamin Franklin HARDY, Nampa, ID (US); Merle Clark HARDY, Thompson, ID (US)

(21) Appl. No.: 17/145,089

(22) Filed: Jan. 8, 2021

(51) Int. Cl. A01D 43/14; A01D 34/64

(52) U.S. Cl. CPC A01D 43/14; A01D 2101/00; A01D 34/64

(57) ABSTRACT

A riding lawn mower that is configured such that an operator can simultaneously mow while selectively apply liquid (such as herbicide) while retaining directional control of the riding lawn mower. This is accomplished by integrating a liquid dispensing control with the mower's steering system, such that the operator does not need to move his control hand from off a control surface of the steering system in order to activate the liquid dispensing control with the same hand. As an example, the liquid dispensing control could be a push button control that is activated by the thumb of the control hand, whilst the fingers and palm of the control hand remain firmly gripped on the control surface of the steering system.

### BACKGROUND

The beauty and comfort of real estate can often be greatly enhanced by a well-manicured lawn. The basics of a good lawn include suitable soil, proper watering, regular mowing, and maintenance. During the active growing season, good lawn care requires regular mowing perhaps once a week or even more often depending on climate. On the other hand, fertilization and weed control are conventionally performed much less frequently, perhaps only several times a year. The purpose of lawn fertilization is to add proper levels of Nitrogen and other essential nutrients to the soil to support lawn growth. Weed and pest control are often done by applying herbicide or pesticide several times per year to help keep weeds and pests under control.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The principles described herein relate to a riding lawn mower that is configured such that an operator can simultaneously retain directional control of a moving riding lawn mower while selectively applying liquid to the lawn. Thus, an operator can simultaneously mow while selectively applying the liquid to the lawn. The liquid can even be selectively applied many times in a single mow without the operator even needing to move his hands off the steering system. As an example, in the case of the liquid being herbicide, the operator simply mows and watches out for areas that need herbicidal application, such as areas that have weeds. The operator continues to mow seamlessly while applying the liquid to the appropriate portions of the lawn as the mower passes over the problem areas.

In one embodiment, this is accomplished by integrating a liquid dispensing control with the mower's steering system, such that the operator does not need to move his or her control hand from off a control surface of the steering system in order to activate the liquid dispensing control with the same hand. As an example, the liquid dispensing control could be a push button control that is activated by the thumb of the control hand, whilst the fingers and palm of the control hand remain firmly gripped on the control surface of the steering system. As a further example, the liquid dispensing control could be a push button at the end of a steering lever of a zero-turn mower. Alternatively, the actuation control could be placed near the foot of the operator such that the foot is used to activate the liquid dispensing control.

This allows the operator to efficiently perform two important tasks of lawn maintenance at a time—lawn mowing and liquid application (e.g., the applying of herbicide). This greatly improves efficiency since mowing and the application of herbicide have typically previously been performed at distinct times. The lawn mower does not even need to stop mowing while the herbicide is being applied. Furthermore, herbicide is more likely to be applied only where weeds are observed, instead of wholesale across larger areas or even the whole lawn. This reduced and more targeted application of chemical agents preserves resources and improves safety due to reduced risk of exposure to chemical agents. Furthermore, the targeted application of liquid has less impact on the environment. Additionally, herbicidal treatment can be performed every mow, leaving weeds little opportunity to get out of control. Once weeds become visible to the operator, herbicide is immediately applied.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 is a component diagram of a conventional riding lawn mower;

FIG. 2 is a component diagram of a riding lawn mower in accordance with the principles described herein, and which further includes a tank and liquid dispensing system for applying liquid from the tank through the dispensing system and onto the lawn;

FIG. 3 illustrates a right perspective view of a riding lawn mower, that represents a specific embodiment of the riding lawn mower of FIG. 2;

FIG. 4 illustrates a schematic diagram of a liquid system that is an example of the liquid dispensing system within the riding lawn mower of FIG. 3;

FIG. 5 illustrates a schematic diagram of an electrical system that is an example of the electrical system within the riding lawn mower of FIG. 3;

FIG. 6 illustrates a top view of the riding lawn mower of FIG. 3;

FIG. 7 illustrates a detailed view of a portion of the riding lawn mower of FIG. 3, which detailed view shows liquid system components and electrical system components; and

FIG. 8 illustrates a detailed lower rearview of the riding lawn mower of FIG. 3, which detailed view shows nozzles spraying liquid from the liquid system to the lawn that the riding lawn mower has just mowed.

### DETAILED DESCRIPTION

The principles described herein relate to a riding lawn mower that is configured such that an operator can simultaneously retain directional control of a moving riding lawn mower while selectively applying liquid to the lawn. The liquid can be selectively applied many times in a single mow without the operator even needing to move hands off the steering system. Thus, mowing and the selective application of liquid can be seamlessly done together. As an example, in the case of the liquid being herbicide, the operator simply mows and watches out for areas that need herbicidal application, such as areas that have weeds. The operator continues to mow while seamlessly and simultaneously applying the liquid to the appropriate portions of the lawn as the mower passes over the problem areas.

This is accomplished by integrating a liquid dispensing control with the mower's steering system, such that the operator does not need to move his or her control hand from off a control surface of the steering system in order to activate the liquid dispensing control with the same hand. As an example, the liquid dispensing control could be a push button control that is activated by the thumb of the control hand, whilst the fingers and palm of the control hand remain firmly gripped on the control surface of the steering system. As a further example, the liquid dispensing control could be a push button at the end of a steering lever of a zero-turn mower. Alternatively, the actuation control could be placed near the foot of the operator such that the foot is used to activate the liquid dispensing control.

This allows the operator to efficiently perform two important tasks of lawn maintenance at a time—lawn mowing and liquid application (e.g., the applying of herbicide). This greatly improves efficiency since mowing and the application of herbicide have typically previously been performed at distinct times. The lawn mower does not even need to stop mowing while the herbicide is being applied. Furthermore, herbicide is more likely to be applied only where weeds are observed, instead of wholesale across larger areas or even the whole lawn. This reduced and more targeted application of chemical agents preserves resources and improves safety due to reduced risk of exposure to chemical agents. Furthermore, the targeted application of liquid has less impact on the environment. Additionally, herbicidal treatment can be performed every mow, leaving weeds little opportunity to get out of control. Once weeds become visible to the operator, herbicide is immediately applied.

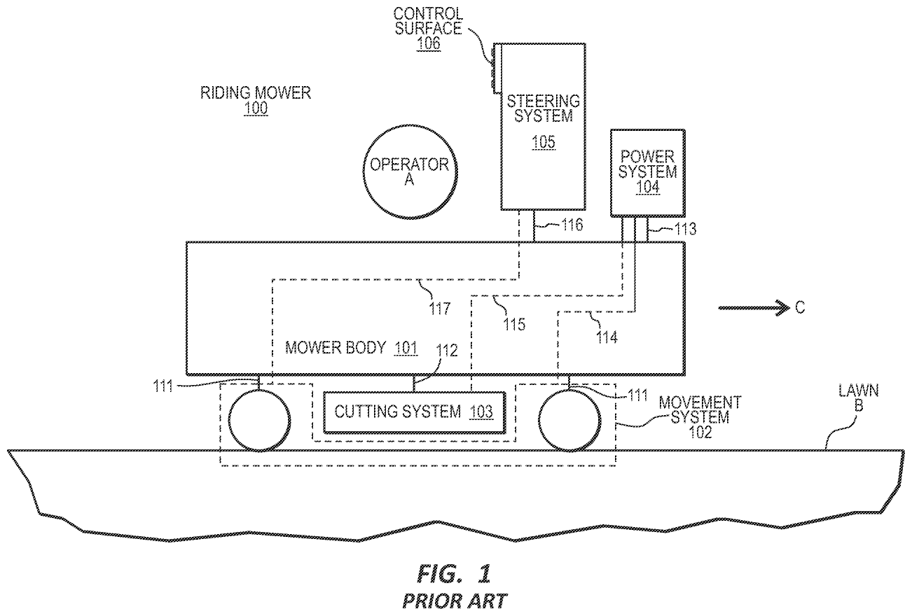

FIG. 1 is a component diagram of a conventional riding lawn mower 100. The component diagram is quite simplified in order to allow attention to focus on the function and interrelationship of the major components and systems of a conventional riding lawn mower. In fact, systems are represented as simple shapes (rectangles and circles) and functional relationships between systems are represented by lines connecting the corresponding simple shapes.

Referring to the simple component diagram of FIG. 1, the riding lawn mower 100 includes a mower body 101, a movement system 102, a cutting system 103, a power system 104, and a steering system 105. The mower body 101 is structured to situate an operator A of the riding lawn mower. As an example, the mower body 101 may have a seat on which the operator sits, or a standing platform on which an operator stands.

The movement system 102 is attached to the mower body 101, as represented by the lines 111. In operation, the movement system 102 engages a lawn B and allows the mower body 101 to move over the lawn B as represented by arrow C. As an example, the movement system 102 may be wheels rotatably attached to the mower body 101.

The cutting system 103 is attached to the lower portion of the mower body 102, as represented by line 112. In operation, the cutting system 103 cuts the lawn B. As an example, the cutting system 103 might typically be mower blades that rotate around an axis that is perpendicular to the lawn, but rotate so as to move in a plane that is parallel to the lawn.

The power system 104 is typically housed within and/or on the mower body 101, as represented by the line 113. The power system 104 is controlled by the operator A so as to selectively cause (as represented by dashed line 114) the movement system 102 to move the mower body 101 over the lawn B, and so as to selectively cause (as represented by dashed line 115) the mower blades 103 to cut the lawn B. As an example, the power system 104 may include a combustion engine.

The steering system 105 is attached to the mower body 102 as represented by the line 116. The steering system 105 could be a steering wheel. Alternatively, zero turn riding mowers often have zero turn levers that the operator grasps (one lever with each hand) to independently control the direction of movement of the left side and right side of the riding lawn mower. Thus, the operator can pivot the mower counterclockwise on the lawn by moving the left side of the mower backwards and the right side of the mower forwards, or can pivot the mower clockwise on the lawn by moving the right side of the mower backwards and the left side of the mower forwards.

The steering system 105 includes a steering control surface 106 that the operator A situated in the mower body 101 can contact with at least one control hand in order to maneuver the steering system 105 to thereby control (as represented by dashed line 117) directional movement of the riding lawn mower 100. For example, in the case of the steering system 105 being a steering wheel, the control surface includes a portion on the left that conveniently receives the grasp of the left hand, and a portion on the right that conveniently receives the grasp of the right hand. In the case of a zero turn mower, the control surface includes a grasping surface of a left zero turn lever that receives the grasp of the left hand, and a grasping surface of a right zero turn lever that receives the grasp of the right hand.

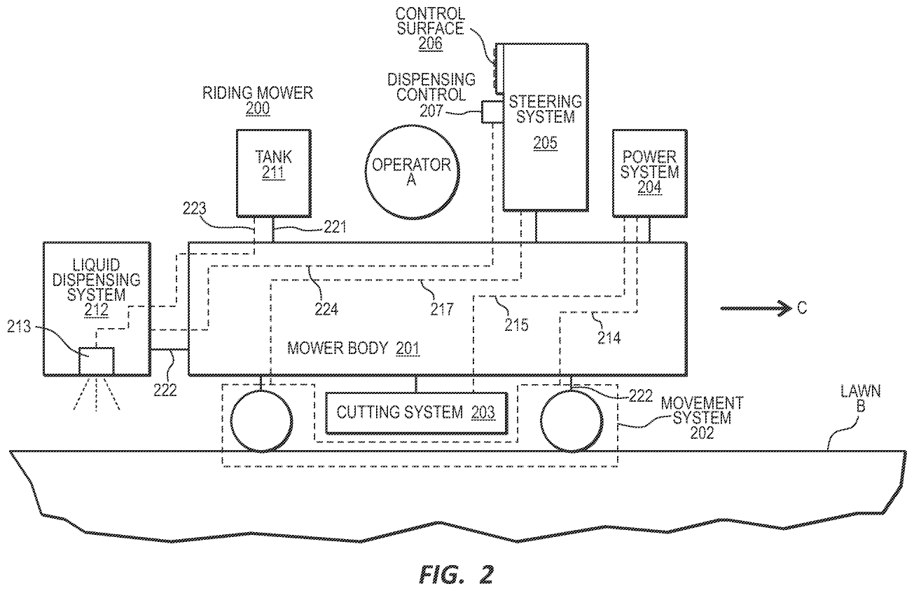

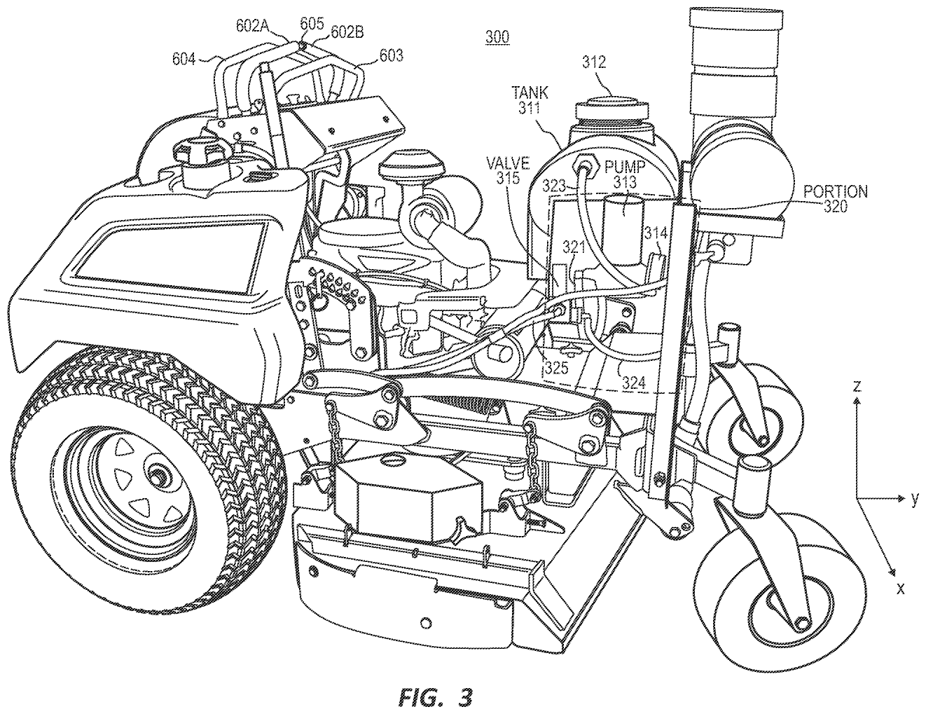

FIG. 2 is a component diagram of a riding lawn mower 200 in accordance with the principles described herein. Again, the component diagram is quite simplified in order to allow attention to be focused on the major components of the system. Furthermore, the general layout of FIG. 2 is similar to that of FIG. 1 to allow for comparison of differences as compared to the conventional riding lawn mower 100 of FIG. 1. Major systems are again illustrated as simple shapes (rectangles and circles) and physical or functional relationships between those systems are represented by lines between the corresponding simple shapes that represent the related systems. A more specific and concrete embodiment of a riding lawn mower that represents an example of the conventional riding lawn mower 200 will be described further below with respect to FIG. 3 through 8.

But for now, we stay with the general embodiment of the riding lawn mower 200 of FIG. 2. The riding lawn mower 200 also includes a mower body 201, a movement system 202, a cutting system 203, a power system 204, and a steering system 205, which may operate as described above for the respective components 101 through 105 of FIG. 1. Although not required, the components 201 through 205 of FIG. 2 may be structured the same as in the corresponding components 101 through 105 of the conventional riding lawn mower 100. In fact, one specific embodiment of a riding mower described below and built by the inventors takes an existing riding lawn mower and modifies it to be further structured in accordance with the principles described herein. More descriptively, the riding lawn mower 200 in accordance with the principles described herein further includes a tank 211, a liquid dispensing system 212, and a liquid dispensing control 207.

The tank 211 is attached to and/or within the mower body as represented by line 221. The tank 211 holds a liquid to be applied to the lawn B. As an example, the liquid may be herbicide to be used for weed control. The liquid dispensing system 212 is attached to and/or within the mower body 201 as represented by the line 222, and may even be distributed through the mower body 201. In operation, the liquid dispensing system 212 is configured to selectively deliver liquid within the tank 211 through at least one delivery nozzle 213 to the lawn C. This delivery path is represented by the dashed line 223 of FIG. 2.

The liquid dispensing control 207 is configured to be used to actuate and deactivate delivery of the liquid through the at least one delivery nozzle 213. This actuation and deactivation control is represented by the dashed line 224. The liquid dispensing control 207 is positioned on the steering system 205 in such proximity to the steering control surface 206 of the steering system 205 such that a control hand of the operator can actuate and deactivate the liquid dispensing control 207 without removing the control hand from the steering control surface 206. Accordingly, the riding lawn mower 200 is configured such that the operator A can both mow and selectively apply liquid from the tank while retaining directional control of the riding lawn mower.

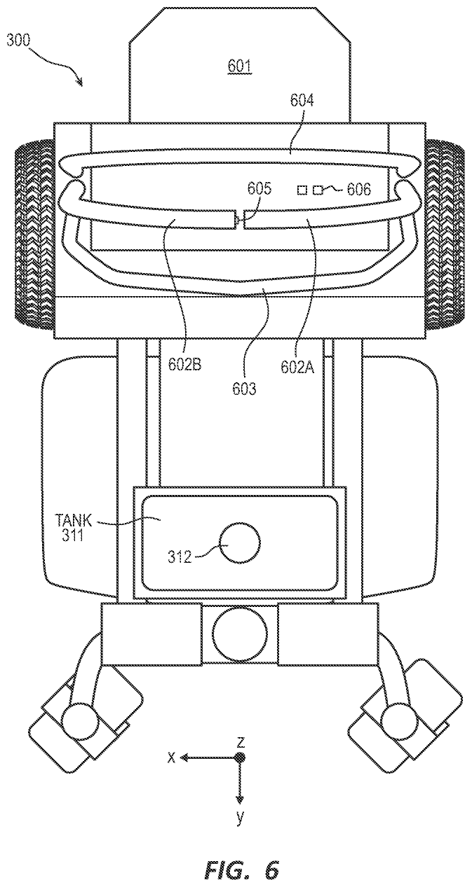

However, FIG. 2 is just a component diagram of a general embodiment of a riding lawn mower 200. On the other hand, FIG. 3 illustrates a right perspective view of a riding lawn mower 300, that represents a specific embodiment of the riding lawn mower 200 of FIG. 2. FIG. 6 illustrates a top view of the same riding lawn mower 300. The top view of FIG. 6 is less detailed than the right perspective view of FIG. 3.

The riding lawn mower 300 is a zero-turn mower in which the operator stands during operation. Referring to FIG. 6, the operator stands on platform 601. The operator 601 controls the direction of the riding lawn mower 300 by moving left zero turn lever 602A and right zero turn lever 602B. Bars 603 and 604 are for the operator to use to maintain balance while standing on the platform 601.

The illustrated lawn mower 300 was constructed by modifying a commercially available riding lawn mower. Specifically, in this example, the commercially available riding lawn mower is a Scags V-Ride II riding lawn mower commercially provided by Scag Power Equipment. However, the principles described herein are not limited to the riding lawn mower 200 being a modified version of a previously manufactured riding lawn mower. That is, the riding lawn mower could be originally manufactured with the additional systems of FIG. 2. Alternatively, or in addition, the riding lawn mower could be a modified version of a riding lawn mower that is not yet designed at the time of the filing of this patent application.

In FIGS. 3, 6 and 8, three orthogonal axes x, y and z are shown. The x-axis is parallel to the width of the riding lawn mower 300. The y-axis is parallel to the length of the riding lawn mower 300. The z-axis is parallel to the height of the riding lawn mower. A “forward direction” is a +y (positive y) direction along the y-axis, and is the same direction as a forward motion of the riding lawn mower 300. A “backward” direction is a −y (negative y) direction along the y-axis that represents rearward motion of the riding lawn mower 300. Generally, the riding mower 300 moves in the forward direction when mowing a lawn. But rearward motion is also possible. A +x (positive x) direction is a rightward direction from the left to the right of the riding lawn mower 300 along the x-axis. A −x (negative x) direction is a leftward direction from the right to the left of the riding lawn mower 300 along the x-axis. A +z (positive z) direction is an upward direction from the bottom to the top of the riding lawn mower 300 along the z-axis. That +z direction comes out of the page towards the reader in FIG. 6. A −z (negative z) direction is a downward direction from the top to the bottom of the riding lawn mower 300 along the z-axis.

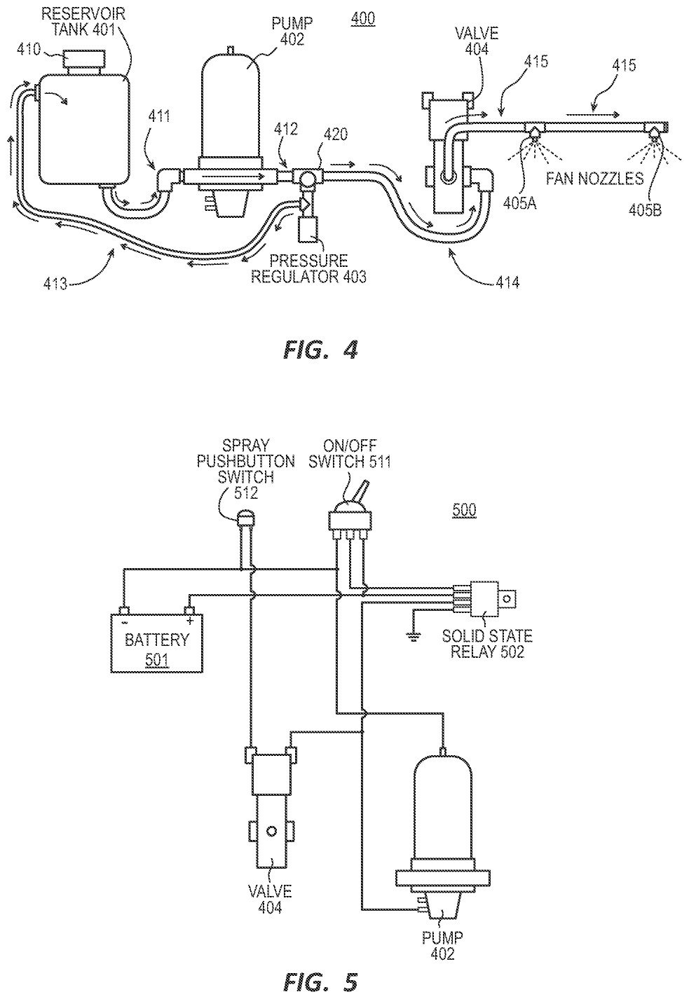

FIG. 4 illustrates a schematic liquid diagram of a liquid system 400, which is an example of fluid components of the liquid dispensing system 212 embodied within the riding lawn mower 300 of FIGS. 3 and 6. FIG. 5 illustrates a schematic electrical diagram of an electrical system 500, which is an example of electrical and fluid components of the liquid dispensing system 212 embodied within the riding lawn mower 300 of FIG. 3. The liquid system 400 and the electrical system 500 will now be described with frequent reference to riding lawn mower 200 of FIG. 2, and the riding lawn mower 300 of FIGS. 3 and 6.

The liquid system 400 includes a tank 401, a pump 402, a pressure regulator 403, a valve 404, fan nozzles 405A and 405B, and various liquid communication devices, including tubes, elbows, and tees. Arrows represent liquid flow directions that occur during various operation times.

In the illustrated embodiment, when the riding lawn mower 300 is in operation, the liquid is recirculated from the reservoir tank 401 through the pump 402, through the pressure regulator 403 and back to the reservoir tank 401. This recirculation path is from the tank 401, through the liquid communication path 411, the pump 402, the liquid communication path 412, the pressure regulator 403, the liquid communication path 413, and back into the tank 401. In operation, the pump 402 causes the liquid to be recirculated from the tank, through the recirculation path and back into the tank, regardless of whether the liquid dispensing control system is actually dispensing liquid through the at least one delivery nozzle 405A and 405B.

In addition, there is an additional one-way liquid path that is selectively activated by the valve 404, and which taps into a portion 420 of the recirculation path that is fluidly closest to the delivery nozzles 405A and 405B. This one-way liquid path may also be referred to as a “terminal path” since liquid that enters the terminal path will exit the system through the nozzles in normal operation.

The terminal liquid communication path includes liquid communication path 414 which taps into the recirculation path and is in liquid communication with the inlet of the valve 404. Furthermore, the outlet of the valve 404 is liquidly coupled via the liquid communication path 415 to the nozzles 405A and 405B. Accordingly, when the valve 404 is opened, the liquid is pushed through the liquid communication path 414, the valve 404, the liquid communication path 415 and through the nozzles 405A and 405B. To the contrary, when the valve 404 is closed, liquid pressure is not significantly applied to the nozzles 405A and 405B, and thus liquid flow is largely, if not wholly, prevented from flowing through the nozzles 405A and 405B.

Because of the recirculation in the recirculation path, air bubbles and sediment cannot easily accumulate in significance within that recirculation path. Thus, liquid can more evenly flow since blockages are prevented, and air bubbles are mitigated. In addition, this recirculation prevents the pump 402 from power cycling or air locking, thereby extending the life of the pump 402. Instead, the pump 402 might power cycle as few as just one time for an entire lawn, or perhaps just when the lawn mower itself power cycles.

In addition, such recirculation means that there is liquid present at the inlet of the valve 404. When the valve 404 is opened, the liquid pressure quickly propagates to the nozzles 405A and 405B for delivery of the liquid to the lawn. Thus, there is no substantial time lag between the time that the valve 404 is opened, and the time that the liquid is delivered to the lawn, or at least that time lag is short enough to be taken into account by the operator when applying liquid to the lawn. Stated a different way, the nozzle reaction time is reduced, allowing the operator to take more intuitive aim of the herbicide at weeds.

The tank 401 is an example of the tank 211 of FIG. 2. A specific example of the tank 401 is represented as the tank 311 of FIGS. 3 and 6. Referring to FIG. 4, the operator can place the liquid (such as herbicide) within the reservoir tank 401 via an opening at the top that is covered by a cap 410. In the concrete examples of FIGS. 3 and 6, the tank 311 includes removable cap 312, which covers an opening in which herbicide may be poured. In the example of FIG. 3, the tank 311 may have a 6 gallon capacity, though the principles described herein are not limited to the capacity of the tank.

Since the liquid is not applied to all of the lawn, but only on selective areas, this capacity is sufficient for even large lawns. As a general average, liquid usage may be at about 1 gallon per acre, though the selective activation while mowing means that this usage can vary as there is need. If the inventive concept has been applied to a given lawn every mow over an extended period of time, there may be times when no herbicide at all is needed, since the lawn has been well maintained with herbicide selectively applied each mow. After all, the principles described herein allow the operator to get well ahead of any weed problem since herbicide can be applied as soon as the operator can see a weed while mowing.

More details regarding example components of the liquid system 400 will now be described. Referring again to FIG. 4, the pump 402 draws liquid from the reservoir tank 401 through the liquid communication path 411, through the pump 402, through the liquid communication path 412, through the pressure regulator 403, through the liquid communication path 413, and back into the reservoir tank 401.

The pump 402 may be, for example, any pump that is compatible with the liquid being applied, and which can pump at a sufficient flow rate through the nozzles 405A and 405B, and which can preferably be powered by a riding lawn mower battery (which is typically 12 volts). As an example only, the riding lawn mower 300 has a pump 313, which is a PENTAIR® SHURFLO® Model 2088-343-136, which is powered by 12 volts DC, is rated for flows up to 3 gallons per minute, and is rated for pressures up to 45 pounds per square inch (PSI). All pressures mentioned herein are relative pressures with respect to atmosphere, rather than absolute pressures with respect to a vacuum. The liquid communication paths 411, 412, 413, 414 and 415 may be composed of ½ inch (inside diameter) PVC tubing with corresponding PVC fittings (elbows, tees, and nozzles).

The pressure regulator 403 ensures that a proper pressure is maintained within the liquid communication paths 411 through 414 (and within liquid communication path 415 when the valve 404 is open). In one embodiment, the pressure regulator 403 is set at 30 PSI, which is high enough to ensure significant flow through the nozzles 405A and 405B, but low enough that the nozzle spraying is controlled at predictable spray angles and not randomly and unpredictably sputtering. Thus, the 30 PSI level of pressure does allow the herbicide to land with sufficient flow on predictable portions of the lawn, at least with the riding lawn mower 300 depicted in FIG. 3. However, the precise optimal pressure will differ depending on the dimensions, properties and components of the liquid dispensing system. In one embodiment, the pressure is regulated to be at a pressure between 15 and 40 PSI.

The valve 404 may be any valve that is compatible with the underlying liquid, and which can operate at the mentioned pressures, and with sufficient flow. In one embodiment, the valve 404 is a TEEJET® AA144-1 DirectoValve rated for flows up to 10 gallons per minute, and up to 100 PSI.

The nozzles 405A and 405B may be fan spray nozzles designed to spray in a fan shape. It is preferred that the nozzles 405A and 405B be arrayed perpendicular to the direction of movement of the riding lawn mower, and such that there is slight overlap of the spray from neighboring fan nozzles. This reduces the chance that there will be a lawn area that is missed by the nozzle spray.

FIG. 5 illustrates a schematic electrical diagram of an electrical system 500 that is used to control the liquid dispensing system 400 of FIG. 4. Specifically, the electrical system 500 controls the pump 402 and the valve 404 of the liquid dispensing system 400. Thus, the pump 402 and valve 404 are also shown as part of the electrical system 500 in FIG. 5. The electrical system 500 uses the battery 501 as an electrical power source. The battery 501 could be, for example, a 12 volt battery that is also used for all other electrical power systems of the riding lawn mower (such as engine ignition). The electrical system also includes a four terminal solid state relay 502. The electrical system 500 also includes two switches 511 and 512 that are controlled by the operator of the riding lawn mower.

The on-off switch 511 turns the pump 402 itself on and off by applying the battery voltage 501 across the pump 402 via the solid state relay 502. This causes the liquid to recirculate through the recirculation path. The inventors expect that this on-off switch 511 will not be cycled on and off very often. For example, the on-off switch 511 might be turned on when lawn mowing begins, and off when lawn mowing ends. When the on-off switch is off, battery power is prevented from being provided to the valve 404 as well. Because of the lower frequency of activation of the on-off switch 511, this switch 511 need not be located on the steering system because it is not necessary that the operator turn this switch on and off while simultaneously driving the riding lawn mower.

The spray pushbutton switch 512 closes to open the valve 404 by applying the battery 501 voltage via the solid state relay 502 across the valve 404. The spray pushbutton switch 512 opens to thereby close the valve 404 by ceasing application of the battery voltage across the valve 404. Thus, the operator applies the liquid (e.g., herbicide) to the lawn by pressing the pushbutton switch 512, and ceases application of the liquid to the lawn by releasing the pushbutton switch 512. The inventors expect that the operator of the riding lawn mower will operate the spray pushbutton switch 512 whenever the operator spots weeds in the lawn, perhaps many times during the mowing of a lawn (or few or no times if the lawn is already relatively weed-free).

The pushbutton 512 may be placed within convenient reach of the operator even when then operator still has the control hand firmly on the control surface of the steering system. As an example, referring to FIG. 6, the pushbutton 512 may be a button 605 that is at the end of the right zero turn lever 602B of the riding lawn mower 300. Accordingly, the operator of the riding lawn mower can easily press and release the spray pushbutton switch 512 without stopping or even perhaps slowing down the lawn mowing operation. For example, referring to FIG. 6, an operator mowing the lawn will have a left hand grasping the left zero turn lever 602A, and a right hand grasping the right zero turn lever 602B. The operator's right thumb may press and release the pushbutton control 605 without even removing the right hand from off the right zero turn lever 602B. Thus, the operator can mow while selectively applying herbicide to the lawn.

In an alternative embodiment, the pushbutton control may be a thumb button positioned at the end of the left zero turn lever. Alternatively, there may be a thumb button at the end of each of the left zero turn lever, and the right zero turn lever. This gives the operator convenience as to how to activate the herbicide spray. Thus, in accordance with the principles herein, there may be two liquid dispensing controls—a first liquid dispensing control that is in such proximity to a first control surface of the steering system such that a first hand of the operator need not be removed from the first control surface in order to activate the first liquid dispensing control, and a second liquid dispensing control that is in such proximity to a second control surface of the steering system such that a second hand of the operator need not be removed from the second control surface in order to activate the second liquid dispensing control. In this case, the liquid dispensing control activated by the left hand might activate nozzles on the left side of the riding lawn mower, and the liquid dispensing control activated by the right hand might activate nozzles on the right side of the riding lawn mower.

In an alternative embodiment, the pushbutton control 512 is situated in the mower body 201 so as to be activated by a foot of the operator A. This permits that hands of the operator to be used to steer the riding lawn mower, and a foot of the operator to be used to control spraying.

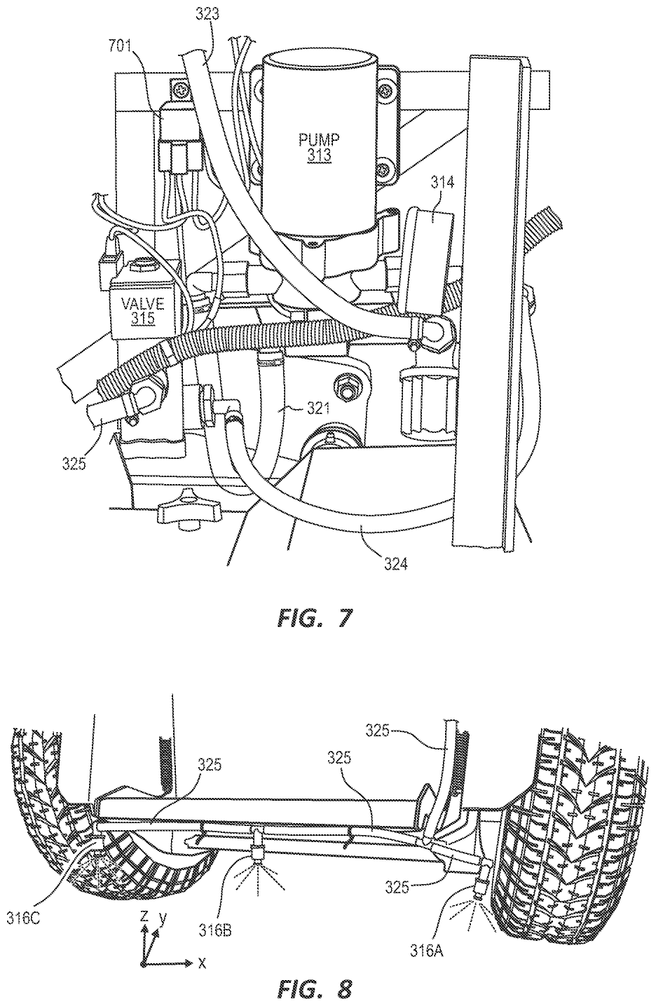

FIG. 7 illustrates a detailed view of a portion 320 of the riding lawn mower 300 of FIG. 3, which detailed view shows liquid system components and electrical system components. Also, FIG. 8 illustrates a detailed lower rearview of the riding lawn mower 300 of FIG. 3, which detailed view shows nozzles spaying liquid from the liquid system to the lawn that the riding lawn mower has just mowed. Accordingly, an example of the liquid system 400 of FIG. 4 and the electrical system 500 of FIG. 5 will now be described with respect to the riding mower 300 of FIGS. 3 and 6, as well as the detailed views of FIGS. 7 and 8.

Referring to FIG. 4, when the pump 402 is on, liquid flows from the reservoir tank 401 through the liquid communication path 411, through the pump 402, through the liquid communication path 412, through the pressure regulator 403, through the liquid communication path 413 and back into the reservoir tank 401. In the example riding lawn mower 300 of FIG. 3 (and the more detailed view in FIG. 7), the liquid is drawn by the pump 313 from the bottom (not shown) of the tank 311, through the tube 321, through the pump 313, through the pressure regulator 314, through the tube 323 and back into the tank 311.

Also referring to FIG. 4, the valve 404, when opened draws liquid from point 420 of the recirculation path through the liquid communication path 414, through the valve 404, through the liquid communication path 415 and to the nozzles 405A and 405B. Referring to FIG. 3 and the more detailed views of FIGS. 7 and 8, the valve 315 draws the liquid through the tube 324, through the valve 315 and through the liquid communication path 325 which leads towards the back of the riding lawn mower.

In FIG. 8, it can be seen that the liquid communication path 325 delivers liquid to the nozzles 316A, 316B, and 316C. Thus, in the riding lawn mower 300, the delivery nozzles are arrange side to side in a width direction (along the x-axis) of the riding lawn mower, and along the back of the riding lawn mower. Thus, a wide swath of liquid can be applied to the lawn. In the illustrated case of FIG. 3, the riding lawn mower has a 48 inch cutting width, the three nozzles 316A, 316B, and 316C are spaced in intervals of 18 inches, are positioned about 6 inches about the lawn, and have a spray angle of 110 degrees. This permits overlap in the spray of neighboring nozzles.

Referring to FIG. 5, the battery 501 selectively delivers electrical power through the solid state relay 502, to the valve 404 and pump 402 as previously described, in accordance with the state of the on/off switch 511 and the spray button switch 512. Referring to FIGS. 3 and 6, the thumb button control in the right zero turn lever 602A is an example of the pushbutton switch 502 of FIG. 5. The switch 606 is an example of the on/off switch 511 of FIG. 5. Referring to FIG. 7, the relay 701 is an example of the solid state relay 502 of FIG. 5. Electrical wiring to and from the spray button switch 512 can be pulled through a hollow center along the length of the right zero-turn lever 602A.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A riding lawn mower configured such that an operator can both mow and selectively apply liquid from the tank while retaining directional control of the riding lawn mower, the riding mower comprising:
a mower body configured to situate an operator of the riding lawn mower;
a directional movement system configured to, in operation, engage a lawn and allow the mower body to move over the lawn;
a power system configured to, in operation, selectively engage with the directional movement system to move the mower body over the lawn;
a steering system attached to the mower body and having a steering control surface that an operator situated in the mower body can contact with a control hand in order to, in operation, maneuver the steering system to thereby control the directional movement system to thereby allow the operator to control directional movement of the riding lawn mower;
a tank attached to mower body, and for holding liquid; and
a liquid dispensing control system configured to, in operation, selectively deliver liquid within the tank through at least one delivery nozzle to the lawn; and
a liquid dispensing control that is configured to be used to actuate and deactivate delivery of the liquid through the at least one delivery nozzle, the liquid dispensing control positioned on the steering system in such proximity to the steering control surface of the steering system such that the control hand can actuate and deactivate the control without removing the control hand from the steering control surface.

2. The riding lawn mower in accordance with claim 1, the control surface being a first control surface, the control hand being a first control hand, the steering system further having a second steering control surface that an operator situated in the mower body can contact with a second control hand in order to, in operation, maneuver the steering system.

3. The riding lawn mower in accordance with claim 2, the liquid dispensing control being a first liquid dispensing control, the liquid dispensing control system configured to, in operation, selectively deliver liquid within the tank through a set of one or more nozzles to the lawn depending on activation of the first liquid dispensing control, the riding lawn mower further comprising:
a second liquid dispensing control that is also configured to be used to actuate and deactivate delivery of the liquid through the set of one or more nozzles.

4. The riding lawn mower in accordance with claim 2, the liquid dispensing control being a first liquid dispensing control, the liquid dispensing control system configured to, in operation, selectively deliver liquid within the tank through a first set of one or more nozzles to the lawn depending on activation of the first liquid dispensing control, the riding lawn mower further comprising:
a second liquid dispensing control that is configured to be used to actuate and deactivate delivery of the liquid through a second set of one or more nozzles that is different than the first set of one or more nozzles.

5. The riding lawn mower in accordance with claim 4, the first liquid dispensing control and the first set of one or more nozzles located on a left half of the riding lawn mower, the second liquid dispensing control and the second set of one or more nozzles located on a right half of the riding lawn mower,

6. The riding lawn mower in accordance with claim 2, the steering system comprising first and second zero-turn levers, the first steering control surface being on the first zero-turn lever, and the second steering control surface being on the second zero-turn lever.

7. The riding lawn mower in accordance with claim 6, further comprising:
wiring for communicating an electrical signal from the liquid dispensing control to a mechanism that selectively applies the liquid to the lawn, the wiring being through a hollow portion of the first zero-turn lever.

8. The riding lawn mower in accordance with claim 1, the liquid dispensing control system comprising:
a terminal path that is liquidly closest to the at least one delivery nozzle, and that includes a valve that is configured to be opened and closed responsive to the liquid dispensing control; and
a recirculation path from an outlet of the tank to an inlet of the tank, the recirculation path comprising a pump that, in operation, causes the liquid to be recirculated from the tank, through the recirculation path and back into the tank, regardless of whether the liquid dispensing control system is actually dispensing liquid through the at least one delivery nozzle, the terminal path of the dispensing control system tapping from a portion of the recirculation path so as to draw liquid from the recirculation path when liquid is dispensed through the valve and through the at least one delivery nozzle.

9. The riding lawn mower in accordance with claim 8, the recirculation path also comprising a pressure regulator.

10. The riding lawn mower in accordance with claim 9, the pressure regulator configured to maintain pressure within the recirculation system at a pressure that is greater than 15 pounds per square inch (psi), but less than 40 psi.

11. The riding lawn mower in accordance with claim 9, further comprising:
a battery that, in operation, provides electrical power to the valve and pump.

12. The riding lawn mower in accordance with claim 9, further comprising:
a power switch that permits electrical power to be connected and disconnected from the valve and pump.

13. The riding lawn mower in accordance with claim 12, the power switch being connected to the mower body so as to not be controllable by a control hand of the operator while the control hand maintains contact with the steering control surface.

14. The riding lawn mower in accordance with claim 1, the liquid dispensing control being a thumb button that is positioned with respect to the steering control surface such that the thumb of a control hand can press on the thumb bottom while the fingers and palm of the control hand remain grasped onto the steering control surface.

15. The riding lawn mower in accordance with claim 1, the at least one delivery nozzle being a plurality of delivery nozzles.

16. The riding lawn mower in accordance with claim 15, the plurality of delivery nozzles arrange side to side in a width direction of the riding lawn mower.

17. The riding lawn mower in accordance with claim 15, the plurality of delivery nozzles arranged at the back of the riding lawn mower.

18. A riding lawn mower configured such that an operator can both mow and selectively apply liquid from the tank while retaining directional control of the riding lawn mower, the riding mower comprising:
a mower body configured to situate an operator of the riding lawn mower;
a directional movement system configured to, in operation, engage a lawn and allow the mower body to move over the lawn;
a power system configured to, in operation, selectively engage with the directional movement system to move the mower body over the lawn;
a steering system attached to the mower body and having a steering control surface that an operator situated in the mower body can contact with a control hand in order to, in operation, maneuver the steering system to thereby control the directional movement system to thereby allow the operator to control directional movement of the riding lawn mower;
a tank attached to mower body, and for holding liquid; and
a liquid dispensing control system configured to, in operation, selectively deliver liquid within the tank through at least one delivery nozzle to the lawn; and
a liquid dispensing control that is configured to be used to actuate and deactivate delivery of the liquid through the at least one delivery nozzle, the liquid dispensing control positioned in the mower body such that the operator's foot can actuate and deactivate the control without removing the control hand from the steering control surface.
